(19) United States
(12) Patent Application Publication
(10) Pub. No.: US 2010/0332405 A1
(43) Pub. Date: Dec. 30, 2010

(54) METHOD FOR ASSESSING REPUTATION OF INDIVIDUAL

(76) Inventor: Chad Williams, Toronto (CA)

Correspondence Address: RIDOUT & MAYBEE LLP, 225 KING STREET WEST, 10TH FLOOR, TORONTO, ON, M5V 3M2, CA

(21) Appl. No.: 12/257,580

(22) Filed: Oct. 24, 2008

Related U.S. Application Data
(60) Provisional application No. 60/982,272, filed on Oct. 24, 2007.

(51) Int. Cl. G06Q 99/00; G06F 17/30

(52) U.S. Cl. 705/319; 707/722; 707/E17.001

(57) ABSTRACT

A business networking system that allows for the assessment of candidates by reviewers, such that the assessments are weighted based on characteristics of the reviewer.

### CROSS-REFERENCE TO RELATED APPLICATION

This application claims the benefit of the filing date of U.S. Provisional Patent Application No. 60/982,272 filed Oct. 24, 2007 under the title METHOD FOR ASSESSING REPUTATION OF INDIVIDUAL.

The content of the above patent application is hereby expressly incorporated by reference into the detailed description hereof.

### FIELD OF INVENTION

A method for vouching for individuals, and for assessing an individual's reputation.

### BACKGROUND OF INVENTION

Typically, before embarking on a new business or social relationship with an unfamiliar person, a reference check of some kind on that person is usually undertaken. This may be done formally or informally. Forms of “formal” reference checks include obtaining the person's credit history, searching for outstanding liens, legal actions, or other negative factors, hiring a private investigator to review the person's previous dealings, determining whether the person is in good standing with their professional organization, trade organization, or social club, etc.

Many times, however, “formal” reference checks are not undertaken. Often, substantial transactions are undertaken between previously unknown individuals or businesses based on a third party “vouchor”. A person or company (the vouchor), will tell one party (the interested party) that the other party (the vouchee) is “good to deal with”, or is “trustworthy”, “generally a good person/reputable business”, etc. Typically, the vouchor is known to both parties, though this is not necessary. Ideally, the vouchor has done business with the vouchee in the past, and is highly trusted by the interested party. In some instances, the vouchor is not known to the interested party, or the vouchee, but knows of the reputation of the vouchee, and is trusted to a certain extent by the interested party.

One example of such a relationship is in cases where a businessperson is undertaking business in a new jurisdiction for the first time. For example, a Canadian businessperson may be looking for an accountant in Japan. The Canadian businessperson may have never had dealings with anyone in Japan before. They may ask a friend or Canadian business colleague to recommend, or “vouch” for someone. Alternatively, they may look to a government agency to suggest or recommend someone.

The vouch is usually in the form of a verbal or written subjective comment about that person from a current or previous business partner, friends, family, or acquaintances. Vouching questions asked are typically: “is that a person that I can trust?”, “does this person have integrity?”, or “is this a friendly person?” Sometimes, a vouch can go further, by answering questions like “you know the way I do business—does this person do business the same way?”, or “you know my personality—are we going to get along?”

In today's global environment, where individuals have increasingly complex and narrow fields of specialization and business is global in nature, finding a vouchor is much more difficult than it was in the past. Globalization of business and social networks have made obtaining vouchors, and obtaining leads for vouchees, an extremely difficult task.

Increasingly, people are relying on strangers as vouchors. It is often viewed as “safer” to conduct business with an unknown person that has been recommended by a second unknown person, rather than an unknown person with no recommendation at all.

Formalized business networking systems also exist.

ZoomInfo (www.zoominfo.com) is a vertical search engine focused on people, companies, and the relationships between them. It uses publicly available web sites as its source to automatically create professionally-focused summaries of the people and companies it finds. The site powers people search for Amazon's A9.com and Business Week. ZoomInfo also allows users to collaborate in the construction of its content by contributing information to their own summaries or building new ones where none exist. Using natural language processing, ZoomInfo crawlers read English sentences (“Steve Jobs co-founded Apple Computer with . . . ”) and understand what they mean. ZoomInfo then extracts relevant pieces of information about people, such as the companies they work for and their job titles. Artificial intelligence algorithms allow ZoomInfo to analyze a Web site and extract information based on an understanding of how the Web site is constructed. The technology can deduce that a specific paragraph describes a company, or that a specific address contains the location of a company headquarters. Once ZoomInfo extracts requested data, information integration logic then sifts through and organizes the data. Biographies of people found on various Web pages are assembled into summaries, and inconsistencies in the information are interpreted and resolved. Essentially, ZoomInfo electronically and automatically summarizes information about a person based on data sourced from web sites.

Dbuz (www.dbuz.com) allows a person to read or write positive and negative feedback on anyone (that has an email address). The feedback is posted anonymously, and a person is able to read, for example, the comments entered about them. Though potentially a business networking system, it is really mainly an ‘entertainment’ or gossip site where a user can hear what people are saying about other people.

Another business networking method is Spoke (spoke.com). Spoke evaluates aggregated email traffic in Microsoft Outlook between Spoke members to determine the strength and reach of their network. “Members of the Spoke community assist in validating where other members work through email signature files in Outlook, thereby contributing to the success and quality of the community data as a whole”.

LinkedIn is another business networking method (www.linkedin.com). In this method, a registered user can maintain a list of contact details of people they know (and, presumably, trust) in business. The people in the list are called “connections”. A user of LinkedIn can invite anyone (whether a LinkedIn user or not) to become a connection. A contact network can be built up using direct connections, each of a users' connections' connections (called 2nd degree connections) and the connections of 2nd degree connections (called 3rd degree connections). This can be used, for example, to gain an introduction to some-one you wish to know through a mutual, trusted contact. As can be imagined, this can result in a long, complex, and intricate referral network. This “gated-access approach”, where contact with any professional requires either a pre-existing relationship or the intervention of a contact of theirs, is intended to build trust among the service's users. However, the fact that a person is a second person's “connection” does not necessarily mean that the first person vouches for the other; it only means that they know one another. Obtaining a “vouch” for a person utilizing the LinkedIn network is a complex process, involving a long chain of emails to a long chain of individuals, where each person asks the next person in the connection chain to vouch for the next. This system is highly inefficient, time consuming, and, in any case, does not lead to a solid “vouch”, since the vouch is only as strong as the weakest link in the chain between the people who know each other, and is really only a “vouch” from one, often distant, person.

Crude vouching systems have also been employed on line. One example is the eBay feedback score system, used on the eBay electronic marketplace (www.ebay.com). The eBay marketplace is a marketplace of millions of individuals, each typically unknown to one another. Every time someone closes a transaction on eBay, they have the opportunity to leave positive, negative, or neutral feedback for the person with whom they have transacted. Feedback scores accumulate. A person wishing to purchase something on eBay can look at the seller's feedback score and can generally tell how many transactions the person has undertaken on eBay, and how reliable they have been in the past in such transactions. However, the eBay system is limited to transactions that have actually taken place on eBay, and is dramatically limited since a person may be a great person, that is completely trustworthy, but has not participated in an eBay transaction before. Alternatively, a person may accumulate an extremely high eBay rating purchasing or selling low price items, in order to conduct a successful fraudulent high price transaction. In the eBay system, each transaction is weighted essentially equally. A rating from an first-time user has the same impact as the rating from a veteran. Second, the eBay system is only sometimes a “peer-review” system, in that the majority of users are either buyers or sellers, and thus the feedback from buyers are directed to sellers and vice versa. In the case of an individual who is both a buyer and a seller on ebay, often, this individual will give positive ratings, even for negative transactions, due to fear of reprisal which would damage their own rating.

Other ratings systems, not business networking methods, also appear on the internet, for example, the book rating system on amazon.com. Individuals rate the books they have read, and those ratings are used and correlated to other people's ratings to make suggestions for other books the person might like. However, these systems are not “peer-review”, since the person doing the rating is not a book; thus the rater does not have a rating, and can not, therefore, have their rating affect the rating they give to the books.

Other non-peer-review ratings services also exist intermittently on the web, including teacher rating sites (ratemyteachers.com) and boyfriend rating sites (ratemyboyfriend.com). However, these sites do not offer objective “peer-reviewed” ratings, since the people doing the rating are not also being rated. For example, the people rating teachers in ratemyteachers.com are not necessarily teachers, and thus are not, themselves, rated. Ratemyboyfriend.com is set up for women rating their boyfriends; the women themselves are not rated, and as such, there is no means of knowing or understanding how reliable (or, alternatively, how vindictive) the comments are.

It would therefore be desirable to have a business networking method wherein a person or business can determine whether a stranger is “vouchable”, that is, a person or business that people would vouch for, and that it is desirable to do business with. It would be desirable to be able to locate such a person or business with confidence. It would also be desirable to be able to, given a proposed person, determine whether that person or business is objectively suitable for the task at hand.

Finally, it would be helpful if such a method had built in controls, whereby it would be difficult for a vindictive person to affect a person's rating by vouching negatively for them, without having repercussions to their own rating. It would be thus desirable for such a system to be a “peer review” system with built-in controls to ensure that the ratings given are as accurate as possible.

### SUMMARY OF THE INVENTION

According to one embodiment of the invention is a method for generating an assessment profile of a candidate comprising the steps of: a. obtaining at least one assessment of the candidate from a corresponding at least one reviewer; b. weighting each of the at least one assessment of the candidate by a characteristic of the corresponding at least one reviewer; and c. combining each of the at least one weighted assessments of the candidate to form the assessment profile of the candidate.

In a further aspect, the assessment profile of the candidate weights any assessments of other candidates obtained from the candidate. In a further embodiment, the corresponding at least one reviewer has an assessment profile and the characteristic utilized to weigh the at least one assessment of the candidate is the assessment profile of the corresponding at least one reviewer, such that a higher assessment profile of the corresponding at least one reviewer is given more weight than a lower assessment.

In a further aspect, the characteristic utilized to weigh the at least one assessment of the candidate is a duration of time the corresponding at least one reviewer has known said candidate, such that a longer duration of time is given more weight than a lower duration of time.

In yet a further aspect, the characteristic utilized to weigh the at least one assessment of the candidate is a nature of the relationship between said corresponding reviewer and the candidate, such that a closer relationship is given more weight than a distant relationship.

In yet a further aspect, the characteristic utilized to weigh the at least one assessment of the candidate is the number of assessments received by said reviewer.

In yet a further aspect, step a. comprises the step of:

i. obtaining an evaluation of at least one trait chosen from a group consisting of core values, personality, thinking process, relationship traits, and task skills.

In yet a further aspect, step a.i. comprises obtaining a relative score of the candidate's tendency between at least one pair of opposed attributes associated with the chosen trait.

In yet a further aspect, the score is calculated on a sliding scale between a first value corresponding entirely to a first one of the pair of opposed attributes and a second value corresponding entirely to a second one of the pair of opposed attributes.

In a further aspect, the first value is assigned a value of 1.

In yet a further aspect, the second value is assigned a value of 10.

In yet a further aspect, the at least one pair of opposed attributes associated with the trait of core values is chosen from a group consisting of [courageous/fearful], [decisive/uncertain], [determined/indecisive], [disciplined/disordered], [focused/directionless], [improves self/stays the same], [nerves strong/jumpy], [organized/disorganized], [punctual/tardy], [reliable/undependable], [respects authority/rebellious], [accountable/irresponsible], [does what is right/does what is convenient], [honest/deceiving], [integrity/dishonest], [sincere/hypocritical] and [trustworthy/dishonest].

In yet a further aspect, the at least one pair of opposed attributes associated with the trait of personality is chosen from a group consisting of [confident/insecure], [good/evil], [grateful/unappreciative], [mature/juvenile], [objective/biased], [outgoing/anti-social], [patient/impatient], [optimist/pessimist], [relaxed/stressed], [serious/flippant], [unpretentious/pretentious], and [well-balanced/uni-dimensional].

In a further aspect of the invention, the at least one pair of opposed attributes associated with the trait of thinking process is chosen from a group consisting of [aware of opportunities/ignorant of opportunities], [clear direction/confused], [comprehends easily/hard time understanding], [embraces change/rejects change], [flexible/stubborn], [intelligent/obtuse], [knowledgeable/ignorant], [observant/oblivious], [openminded/guarded], [perfectionist/sloppy], [practical/unrealistic], [resourceful/uninspired], and [sees the whole picture/sees only parts of the picture].

In a further aspect of the invention, the at least one pair of opposed attributes associated with the trait of relationship traits is chosen from a group consisting of [selfless/selfish], [clear communicator/confusing], [cooperative/unhelpful], [courteous/rude], [effective delegator/authoritarian], [forgiving/spiteful], [friendly/hostile], [generous/miserly], [interested/indifferent], [kind/mean], [leader/follower], [loyal/double-crossing], [tolerant/intolerant], [personable/distant], [polite/impolite], [sensitive/aloof], [sympathetic/unfeeling], [thoughtful/callous], and [trusting/jealous].

In a further aspect of the invention, the at least one pair of opposed attributes associated with the trait of task skills is chosen from a group consisting of [ambitious/unmotivated], [energetic/easily tired], [enterprising/not creative], [enthusiastic/indifferent], [hard-working/lazy], [involved/complacent], [keen/reluctant], [persevering/relenting], [self-directed/needy], [strong/frail], [tough/weak], [achieves/doesn't achieve], [detail-oriented/sloppy], [efficient/wasteful], [professional/amateurish], [self-reliant/dependent], [self-directed/dependent], and [systematic/disorganized].

In a further embodiment of the invention is provided a system for generating an assessment profile of a candidate, comprising: an assessment creator for obtaining at least one assessment of the candidate from a corresponding at least one reviewer; an assessment weighter for deriving at least one weighted assessment corresponding to the at least one assessment of the candidate and an assessment profile of the corresponding at least one reviewer; a profile generator for combining each of the at least one weighted assessments of the candidate to form the assessment profile of the candidate.

In a further embodiment of the invention is provided an assessment creator for obtaining an assessment of a candidate from a reviewer, wherein the assessment may be weighted in accordance with an assessment profile of the reviewer and combined with any other existing weighted assessments of the candidate from other reviewers to form an assessment profile of the candidate.

In a further embodiment of the invention is provided an assessment weighter for deriving a weighted assessment of a candidate from a reviewer comprising: means for receiving an assessment of the candidate from the reviewer; and means for retrieving an assessment profile of the reviewer; whereby the assessment may be weighted by the assessment profile and combined with any other existing weighted assessments of the candidate from other reviewers to form an assessment profile of the candidate.

In a further embodiment of the invention is provided an assessment profile generator for generating an assessment profile of a candidate comprising: means for receiving a first weighted assessment of the candidate from a first reviewer; means for receiving a second weighted assessment of the candidate from a second reviewer; and means for combining the first and second weighted assessments of the candidate into the assessment profile; wherein the first and second weighted assessments are derived from respective assessments of the candidate by respective reviewers and an assessment profile of the respective reviewer.

In a further embodiment of the invention is provided a computer-readable medium in a processor for generating an assessment profile of a candidate, the medium having stored thereon, computer-readable and computer-executable instructions which, when executed by the processor, cause the processor to perform steps comprising: a. obtaining at least one assessment of the candidate from a corresponding at least one reviewer; b. weighting each of the at least one assessment of the candidate by an assessment profile of the corresponding at least one reviewer; and c. combining each of the at least one weighted assessments of the candidate to form the assessment profile of the candidate.

### BRIEF DESCRIPTION OF THE FIGURES

FIG. 1 is a schematic drawing of an example of the business networking method that is an aspect of the present invention.

FIG. 2 shows a mock-up of the Vouching Page of the Vouch-Net site, one embodiment of the invention.

FIG. 3 shows a sample Vouchable Attribute Data entry page.

FIG. 4 is a mock-up of the home page of the Vouch-Net site, one embodiment of the invention.

FIG. 5 is a mock-up of the Vouch Results Page of the Vouch-Net site, one embodiment of the invention.

FIG. 6 is a mock-up of the Private Data Entry page of the Vouch-Net site, one embodiment of the invention.

FIG. 7 is a mock-up of the Public Data Entry page of the Vouch-Net site, one embodiment of the invention.

### DETAILED DESCRIPTION OF A PREFERRED EMBODIMENT

In this description, the following terms have the following meanings:

“voucher” is a person or business vouching for the vouchee, for example, by entering qualitative or quantitative data, impressions, or reputation characteristics about a vouchee, who is a person or business they know or have done business with.

“vouchee” is a person or business being vouched for.

An “interested party” is a person or business seeking to determine the reputation or characteristics of the vouchee.

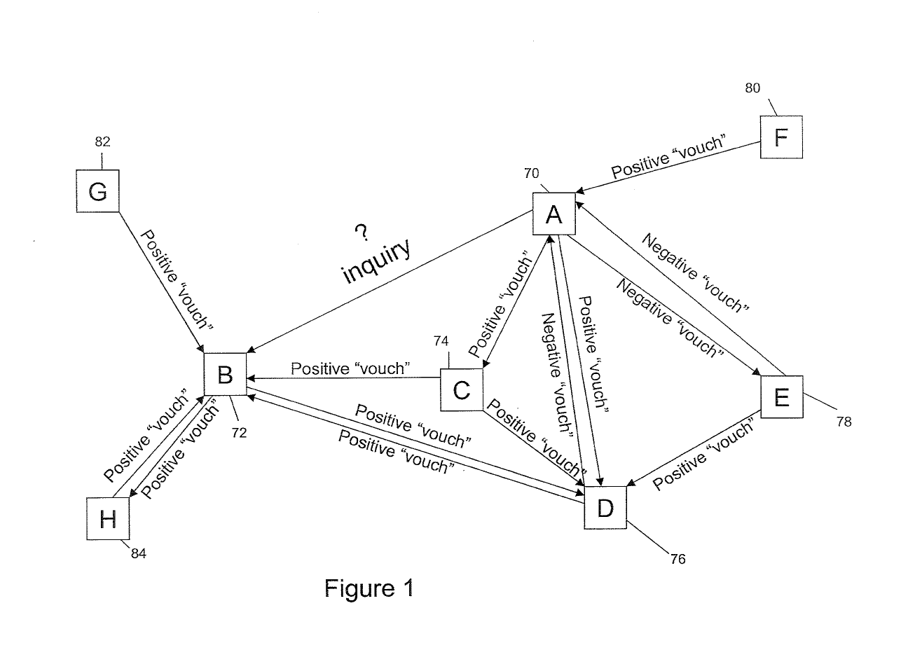

The same person may be a voucher, a vouchee, and an interested person. See, for example, FIG. 1. Person A (70) may be seeking a business partner in China (person B (72)), thus being an “interested person”. That same person A (70) may have vouched for persons C (74), D (76), and E (78), people with which, person A (70) has done business. In this example, A (70) has vouched positively for persons C (74) and D (76), but has negative things to say about person E (78). Thus person A (70) is a voucher for persons C (74), D (76) and E (78). At the same time, or before, or after, persons D (76), E (78) and F (80) may have vouched for person A (70), thus making person A (70) a vouchee with respect to persons D (76), E (78) and F (80). In this example, though A (70) had positive things to say about D (76), the feeling was not mutual. D (76) and E (78) both had negative things to say about A (70), though F (80) vouched positively for A (70).

In this example, A (70) is interested in determining whether B (72) is a person they wish to do business with. We can see that B (72) has “all positive” vouches. Four people have vouched for B (72): C (74), D (76), G (82) and H (84). However, each of these four people may (1) feel stronger or less strongly about their vouching for B (72); (2) may have different amount of interactions with B (72); (3) may have different relationships with B (72); (4) may be more or less reliable as vouchers. For example, for A (70), the vouches from C (74) and D (76) may have more weight than the vouches from G (82) and H (84), since C (74) and D (76) are people with whom A (70) has done business, and thinks positively of. Second, a vouch from D (76), who has been vouched for by 2 independent people (and a total of 4 people) may be worth more than a vouch from G (82), a relative stranger to the system. The fact that D (76) gave A (70) a negative vouch, but B (72) a positive vouch, may also have impact, because it implies that not all of D's vouches are laudatory. If A (70) knew that B (72) and H (84) were brother and sister, for example, he may not place much weight on their mutual vouching for each other. If A (70) knew that C (74) and B (72) had been working together for years, that might be a better vouch.

A voucher, or “reviewer” of a vouchee (or “candidate”) could vouch for that candidate using a simple rating system, such as “would you do business with the vouchee again? Yes/No”. The vouching could also be done utilizing a 1-5 scale, with 5 being “Highly rated” and 1 being “very low rated”. In one embodiment, a range of questions or criteria are employed to determine an objective rating based on a range of subjective “vouchable attributes” describing the candidate. These “vouchable attributes” can describe a variety of attributes, and, in one embodiment, are categorized as a scale where both ends of the scale are subjective, ranging from a positive attribute to a negative attribute. Examples of vouchable attributes are listed in Table 1, along with the positive and negative attributes:

TABLE 1
Vouchable Attributes
1) Core Values

| | |
|---|---|
| Part 1: Discipline | |
| Courageous | Cowering/Fearful |
| Decisive | Uncertain |
| Determined | Indecisive/Unsure |
| Disciplined | Disordered/Chaotic |
| Focused | Scattered/Directionless |
| Improves Self | Stays The Same |
| Nerves Strong | Jumpy |
| Organized | Disorganized |
| Punctual | Tardy |
| Reliable/Responsible | Undependable |
| Respects Authority | Rebellious |
| Part 2: Integrity | |
| Accountable | Irresponsible |
| Does What Is | Does What Is Convenient |
| Necessary/Right | |
| Honest | Deceiving/Lying |
| Integrity | Dishonest |
| Sincere | Hypocritical |
| Trustworthy | Dishonest |

2) Personality

| | |
|---|---|
| Confident | Unsure/Insecure |
| Good | Evil |
| Grateful | Unappreciative |
| Mature | Juvenile |
| Objective/Realistic | Biased |
| Outgoing | Anti-Social |
| Patient | Impatient |
| Positive Attitude/Optimist | Gloomy/Grumpy |
| Relaxed/Clam | Stressed/Tense |
| Serious | Silly/Flippant |
| Unpretentious/Humble/Modest | Ostentatious/Show-Off |
| Well-Balanced | Uni-Dimensional |

3) Thinking Process

| | |
|---|---|
| Aware Of Opportunities | Ignorant Of Opportunities |
| Clear Direction/Clear Goals | Confused/Unfocused |
| Comprehends Easily | Hard Time Understanding |
| Embraces Change | Rejects Change |
| Flexible | Stubborn |
| Intelligent | Obtuse |
| Knowledgeable/Insightful | Ignorant/Uniformed |
| Observant | Oblivious |
| Open/Minded | Guarded/Secretive |
| Perfectionist | Sloppy |
| Practical | Unrealistic |
| Resourceful/Imaginative | Uninspired |
| Sees The Whole Picture | Seeing Only Parts Of The |
| | Picture |

4) Relationship Traits

| | |
|---|---|
| Altruistic/Selfless | Selfish |
| Clear Communicator | Confusing |
| Cooperative | Unhelpful/Confrontational |
| Courteous/Respectful | Rude/Impolite |
| Effective Delegator | Authoritarian/Controlling |
| Forgiving | Spiteful |
| Friendly | Hostile |
| Generous | Miserly/Selfish/Stingy |
| Interested | Indifferent/Uncaring |
| Kind | Cruel/Mean |
| Leader | Follower |
| Loyal | Double-Crossing |
| Tolerant | Close-Minded/Intolerant |
| Personable | Distant/Cold |
| Polite/Well-Mannered | Impolite/Rude/Inconsiderate |
| Sensitive/Shows Empathy | Aloof/Apathetic |
| Sympathetic | Unfeeling/Uncaring |
| Thoughtful/Considerate/Caring | Callous |
| Trusting | Jealous/Envious/Suspicious |

5) Task Skills.

| | |
|---|---|
| Part 1: Energy | |
| Ambitious/Initiative | Unmotivated |
| Energetic/Dynamic | Easily Tired/Fatigued/Listless |
| Enterprising | Not Creative |
| Enthusiastic/Motivated | Indifferent |
| Hard-Working/Has | Lazy/Lethargic |
| Initiative/Dynamic | |
| Involved | Complacent/Indifferent |
| Keen | Reluctant |
| Perseverance/Endurance/Persistent | Relents/Gives Up |
| Self-Directed | Needy |
| Strong/High Stamina/Tough | Frail/Weak/Soft |
| Part 2: Quality | |
| Achieves | Doesn't Achieve |
| Detail-Oriented/Careful | Sloppy |
| Efficient/Manages Time & Resources | Wasteful |
| Well | |
| Professional | Amateurish |
| Self-Reliant/Self-Directed | Dependent |
| Systematic/Deliberate | Disorganized/Disorderly |

Based on any of these methods for assessing a candidate, the assessment is summarized, tabulated, or, preferably, converted into a numerical designation. For example, if a 1-5 scale is used, that same scale can be used as the numerical designation. Alternatively, the ratings on the subjective criteria, shown in Table 1, can be converted into a numerical designation, either for each of the categories (for example, a number from 1-5 for each of “task skills”, “relationship traits”, “thinking process”, “personality”, and “core values”, or an overall numerical designation for the person.

In the example depicted in FIG. 1, for example, A (70) may have assessed C (74) using the criteria in Table 1, which translated into a total score of 4.3. Since A (70) is the only person to vouch for C (74), C's rating would be 4.3.

However, for example, D (76) was vouched for by four different people: E (78), A(70), C (74) and B (72). The easiest way of determining an aggregate score for D (76) would therefore be to use the average (mean, or possibly median) score given to D (76) by these four individuals. However, a better way of determining a score for D (76) would be to perform a weighted assessment of these four scores.

The weighted assessment can be weighted in a number of different ways, by using a number of different weighting criteria. The weighting criteria can also be used in combination, and each different weighting criteria can also be weighted differently.

Examples of weighting criteria that can be used include:
(1) length of time that the voucher has known the vouchee;
(2) nature of the relationship between the vouchee and the voucher; and
(3) the rating of the voucher;
(4) the number of “vouches” obtained by the voucher;
(5) the “accuracy” of the rating;

Again, turning to the example in FIG. 1, if it is known that E (78) and D (76) have been doing business extensively for 10 years, and that D (76) and C (74) just met, E's assessment of D may carry more weight than C's assessment. E's assessment of D may also carry more weight than A's, if it is known that A (70) and D (76) have also known each other for 10 years, but are only acquaintances. D's (76) assessment of B (72) may carry more weight than A's (70) assessment of B (72) (had A assessed B), since D (76) has been universally positively rated, whereas A would have a lower rating, since E (78) and D (76) have given A (70) negative ratings. Weighting criteria (5) may have impact in the case of H's (84) rating, if H (84) and B (72) are related: if all of the ratings for B (72) are around 2.5, with the exception of H's (84), who has given B a rating of 5.0, H's rating would have less impact, as less accurate.

Thus a peer-review system is ameliorated dramatically when the “vouching system” is weighted. Such weighting also prevents abuse of the system, and provides incentive for providing accurate ratings.

Weighting criteria can be used to determine the weighting of the rating given; they can also be used to affect the vouchor's score. In the example provided in FIG. 1, if H (84) has been identified as giving inaccurate or less correlatable vouches, that may effect H's own rating, the weighting given to the scores H gives to anyone H rates, or may simply be applied to the weighting given to H's rating of B.

One embodiment of the invention is typified in the Vouch-net system, a computerized system with a web-enabled interface.

In the Vouch-net system, Vouchers, or assessors, of a candidate, would press on a “volume-bar” with end points at either end of the negative/positive extremes. For example:

### Enterprising [----------( )-------------------------] Not Creative

### Or

### Leader [---------------------------( )--------] Follower

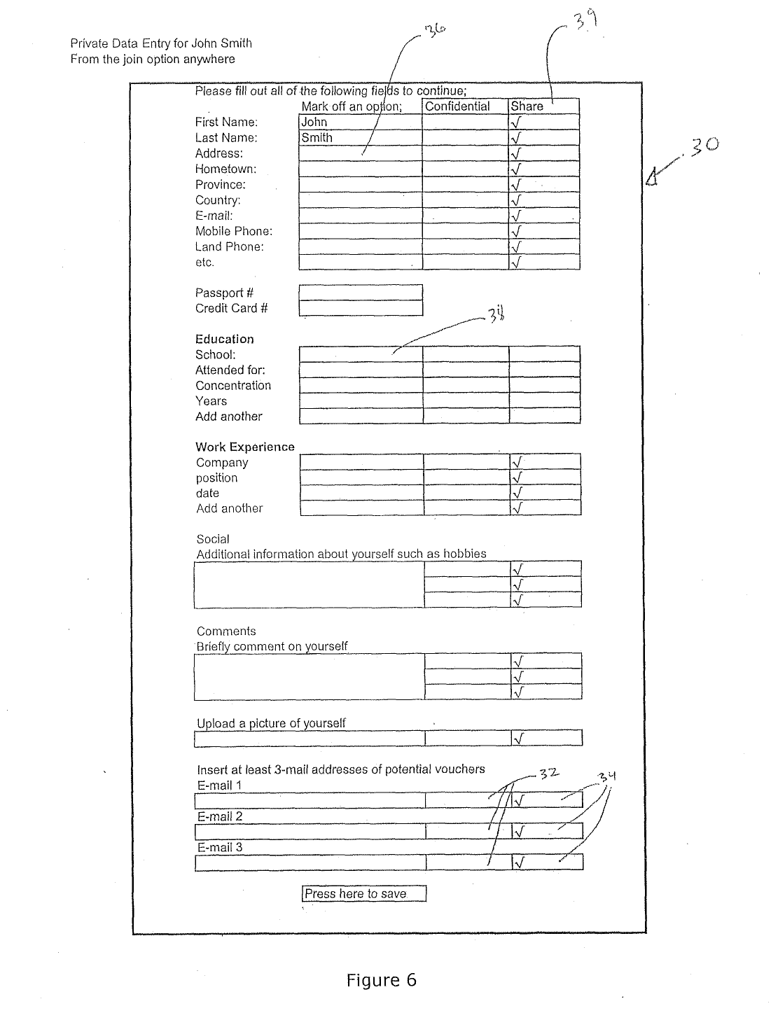

The vouching process is described more fully later in this text, and in FIG. 6.

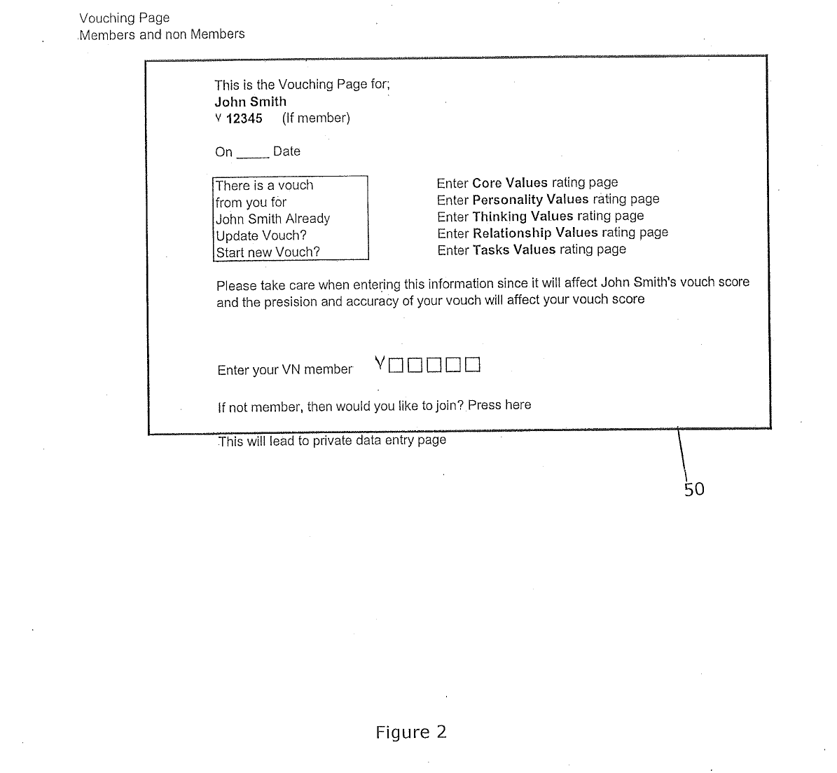

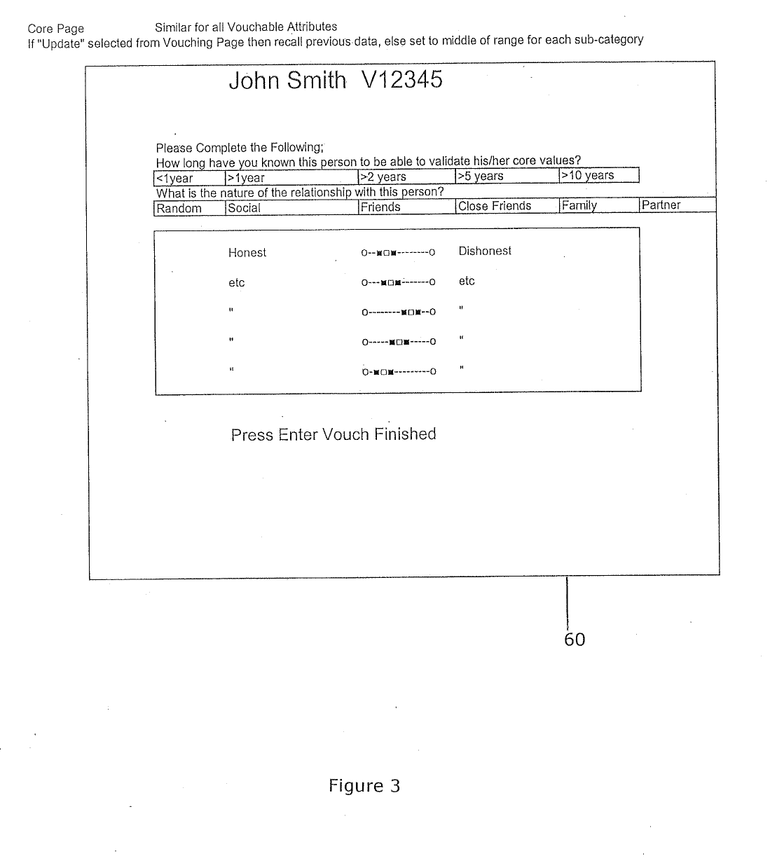

The vouching page (50) is shown in FIG. 2; FIG. 3 shows a sample vouchable attribute data entry page (60). In this case the “core-values” data entry page is shown.

The information entered by the voucher into the Vouching Page (50) and the vouchable attribute data entry page (60), consisting of numerical data (scores), subjective “sliding scale” assessments as previously described, and/or written comments, is reported back to the vouch results page.

The individual vouchable attribute score (“IVA”; one for each vouchable attribute per voucher) is from 1 (low) to 5 (high) and will include one decimal place e.g. 3.2. The average of all core-values sub-categories (e.g. there are 17 for the core-values vouchable attribute) is weighted by:
(1) length of time that the voucher has known the vouchee (longer is better),
(2) nature (closer is better) of the relationship between the vouchee and the voucher, and
(3) the aggregate Vouch-net score (“AVS”) of the voucher (higher is better); the AVS is explained later in this document.

During the vouching process, a voucher may choose to complete one, several, or all 5 vouchable attribute pages depending on the nature of the relationship between the voucher and the vouchee. For example, a voucher that has worked with a vouchee may be comfortable completing the task-skills vouchable attribute page but not the core-values page.

To prevent the elimination of non-favorable vouches, the vouchee cannot prevent the completion of any vouching page once membership into Vouch-net has been established.

For each vouchee, once a minimum of 3 different vouchers enters a score for any individual vouchable attribute, then an aggregate vouchable attribute (“AVA”) score (23) equal to the weighted average of the IVA scores displays in the vouch results page.

Once all 5 aggregate vouchable attribute scores have been established, the aggregate vouch-net score (“AVS”; equal to the average of the AVAs) (22) is calculated. This is the most important number in the Vouch-net system since it is the overall rating of each vouchee. This number will be from 1 (low) to 10 (high) also and will include one decimal place e.g. 4.3.

A non-member is allowed to complete the entire vouching process described above but the scores are for display only and are not used to calculate the AVS.

Comments by the vouchee and the voucher may be added when completing the IVA and the AVS to provide further information about the vouchee and for the vouchee to explain any anomalies in the vouch.

Over time, as new IVAs are completed for this vouchee, the AVS for the vouchee changes. Also, if a voucher's own AVS changes because of new favorable or unfavorable vouches, then this will affect the scores in ALL the vouches that this voucher has completed. Further, a voucher may submit new IVAs for the vouchee and this becomes the current vouch on file.

Each IVA completed by a voucher will be compared to the IVA completed by other vouchers for the same vouchee to see how accurate the vouchers are (measured by standard deviation from the mean score). An accuracy score will thus be assigned to the voucher which will modify the voucher's own IVAs (for example in the task skills vouchable attribute). In addition, a precision score will be assigned to each voucher for each IVA completed. Therefore, each voucher will be encouraged to completed many vouches thoroughly.

Note that the accuracy and precision scores for all vouchers will continue to changes over time as more vouches are entered for each vouchee that the voucher has completed a vouch for (of course this in turn changes all the scores of the vouchees also). Eventually, as more and more vouches are completed, the variations will be small as the vouches approach a mean.

The identity of each voucher (unless anonymous) will be shown on each vouchee's page thereby creating a network of vouchers. A Google Map or similar plot of the vouch network is also possible. Further, GPS identification of vouchees and vouchers could be undertaken using GPS-enabled cell phones for example. Users could verify which Vouch-net members are in the area and this could lead to new business or social relationships.

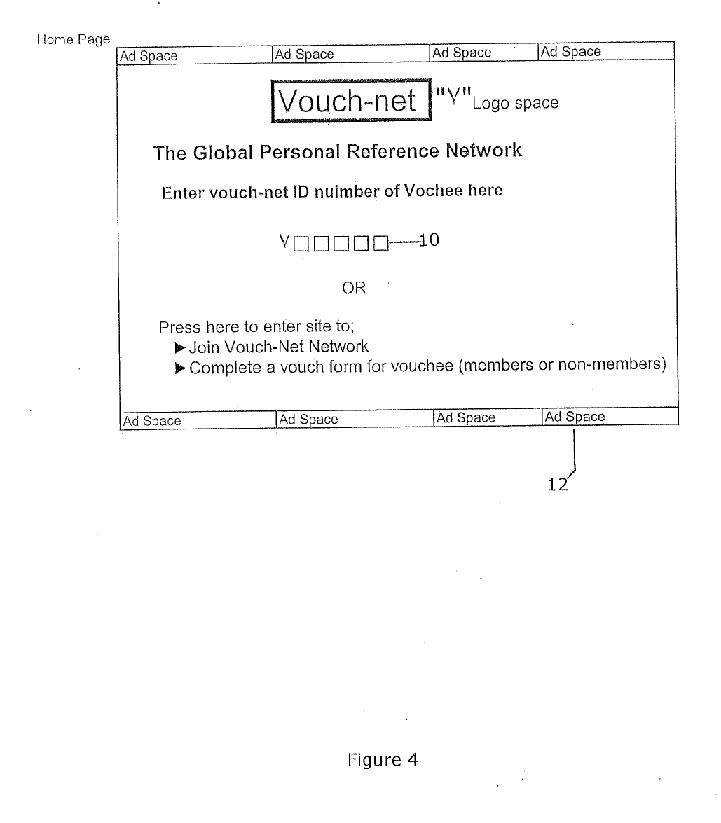

In Vouch-net, an interested person can enter any vouchee's email address, name, or “Vouch-net id number” (the analogy is a phone number; will have the form “v1234567”) into a box (10) on the home page (12) of the vouch-net site web to learn information about the vouchee as shown in FIG. 4. The Vouch-net id number is associated with a specific individual vouchee, and the information in the system about that vouchee.

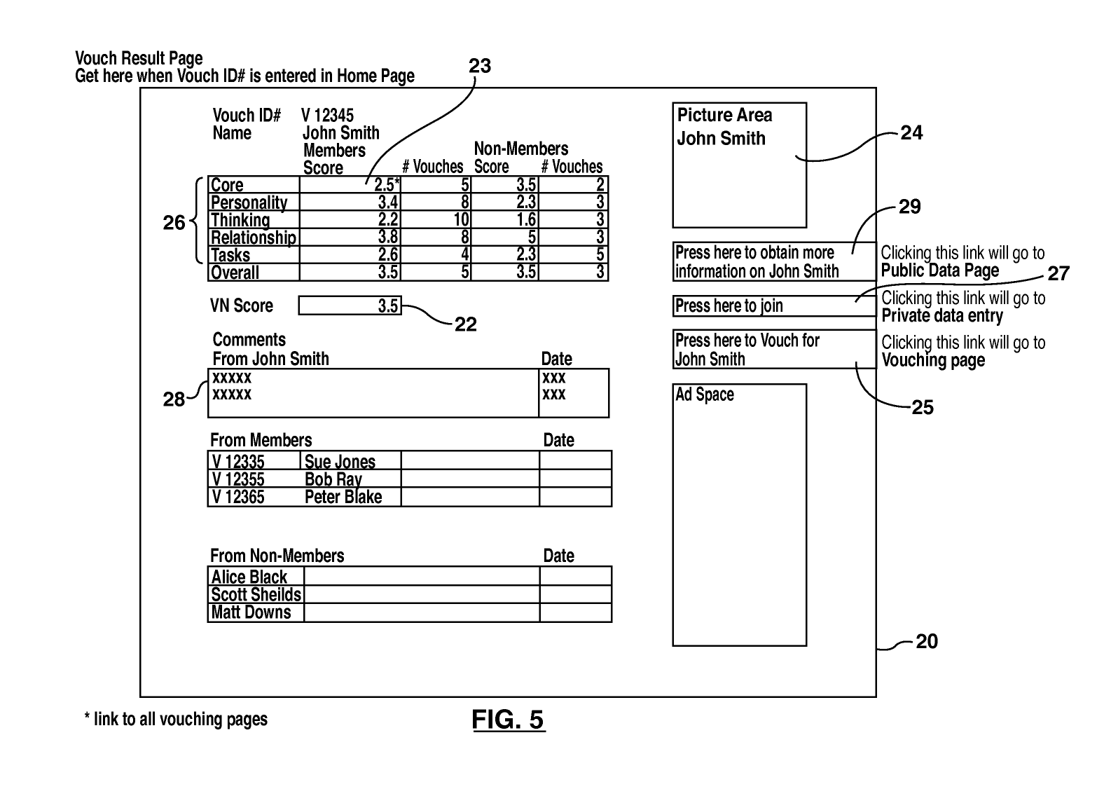

Once the interested person has entered the vouch-net id number, the Vouch-net system compares that number to its database, accesses that vouchee's information, and sends the user to the vouch results page, (20) as shown in FIG. 5, which reveals the vouchee's aggregate Vouch-net score (“AVS”) (22). The vouch results page (20) may also show other information about the vouchee, such as a picture of the vouchee (24), a breakdown of the vouchnet score based on general core categories (26), as explained further below, and more subjective and specific comments (28) about the vouchee from other vouchors.

The AVS (22) is a number that can be used by the interested person to assess the reputation or characteristics of the vouchee, and is based on the information about the vouchee, entered into the system by vouchors (more information on the vouching process, where vouchers vouch for vouchees, will be discussed later).

The AVS (22) is a composite score, based on certain subjective criteria entered by vouchors, known as “vouchable attributes”. The subjective criteria can be rated, for example, on a scale of 1-5 (for example, how nice is the person, on a scale of 1-5), or on a subjective scale from a positive attribute to a negative attribute, as described and illustrated above in Table 1 and FIG. 3.

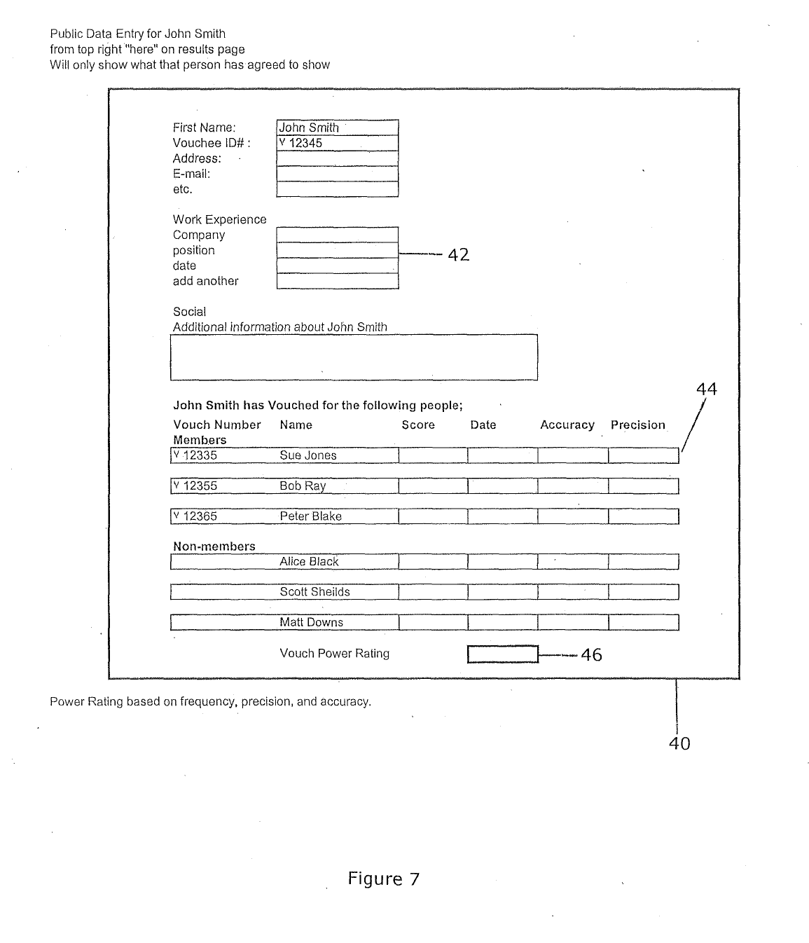

If desired by the user, additional data about the vouchee such as a resume, an address, or a list of interests and hobbies can be accessed on another page (the Public Data Entry Page (40) as shown in FIG. 7) by depressing button 29 on the vouch result page (20). Much of this data would have had to be entered by the vouchee themselves, upon or after joining the site, using the Private Data Entry Form (30) as described below.

The Public Data Entry Page (40) shows information about the vouchee, as entered by the vouchee, such as their work experience (42), as well as details as to who the vouchee has vouched for (44). Optionally, a “vouch power rating” (46) can be calculated for each individual on the system, as described below, and can be used to weigh or balance the individual's VLS, or the VLS of the people for whom the individual is vouching. The Vouch Power Rating (46) can be based on the number of people vouched for, the accuracy of vouches (based on the correlation between the vouches of the individual, and the vouches entered by other individuals for the same vouchee), or another assessment of value, such as the frequency of vouches.

Vouch-net is not able to judge the merits of a person's ability to do any specific particular task, nor is it a gossip-gathering web site that collects trivial information about a person. Instead, the Vouch-net system provides information about the fundamental make-up of a person that is initially unknown to the user of Vouch-net, as substantiated by, or “vouched for” by others. Vouch-net is a first step in building new business and personal relationships. The applications are limitless; for example, salespeople and tradesmen can advertise their AVSs to gain new customers and anyone can use the system to start new social relationships.

Any individual can join the Vouch-net system by entering the website and completing a sign-in procedure. The sign-in procedure is important and must firmly establish a person's identity (potentially using the global anti-money-laundering system ID process plus credit card information, an email address, and a passport-type picture). A person joining vouch-net would be directed to the private data entry page (30) as shown in FIG. 6.

Confidentiality and integrity of the Vouch-net web site will be of utmost importance to Vouch-net users so existing well-trusted web-site firewall systems will be needed to keep user data private.

On the private data entry page, the vouchee enters a list of email addresses and/or Vouch-net ID numbers of all the existing Vouch-net members or non-members that the vouchee intends to ask for a vouch. An email message will automatically be sent to these potential vouchers asking each of them to voluntarily complete a vouching page for the vouchee.

The private data entry page (30) also allows a user/voucher to enter data about themselves, such as their address (36), education information (38), and the like, and the user/voucher can choose whether such information will be shared with interested individuals by toggling a “share” column (39).

Though the embodiment described above is between individuals, it would be apparent to a person skilled in the art that the method could apply to businesses, or other entities. Though the embodiment described above uses the internet as a platform, it would be apparent to a person skilled in the art that any suitable platform may be utilized. The examples above are non-limiting, and meant to teach the invention and outline certain embodiments of the invention.

1. A method for generating an assessment profile of a candidate comprising the steps of:
a. obtaining at least one assessment of the candidate from a corresponding at least one reviewer;
b. weighting each of the at least one assessment of the candidate by a characteristic of the corresponding at least one reviewer; and
c. combining each of the at least one weighted assessments of the candidate to form the assessment profile of the candidate.

2. A method according to claim 1, wherein the assessment profile of the candidate weights any assessments of other candidates obtained from the candidate.

3. A method according to claim 1, wherein the corresponding at least one reviewer has an assessment profile and the characteristic utilized to weigh the at least one assessment of the candidate is the assessment profile of the corresponding at least one reviewer, such that a higher assessment profile of the corresponding at least one reviewer is given more weight than a lower assessment.

4. A method according to claim 1, wherein the characteristic utilized to weigh the at least one assessment of the candidate is a duration of time the corresponding at least one reviewer has known said candidate, such that a longer duration of time is given more weight than a lower duration of time.

5. A method according to claim 1, wherein the characteristic utilized to weigh the at least one assessment of the candidate is a nature of the relationship between said corresponding reviewer and the candidate, such that a closer relationship is given more weight than a distant relationship.

6. A method according to claim 1, wherein the characteristic utilized to weigh the at least one assessment of the candidate is the number of assessments received by said reviewer.

7. A method according to claim 1, wherein step a. comprises the step of:
i. obtaining an evaluation of at least one trait chosen from a group consisting of core values, personality, thinking process, relationship traits, and task skills.

8. A method according to claim 7, wherein step a.i. comprises obtaining a relative score of the candidate's tendency between at least one pair of opposed attributes associated with the chosen trait.

9. A method according to claim 8, wherein the score is calculated on a sliding scale between a first value corresponding entirely to a first one of the pair of opposed attributes and a second value corresponding entirely to a second one of the pair of opposed attributes.

10. A method according to claim 9, wherein the first value is assigned a value of 1.

11. A method according to claim 9, wherein the second value is assigned a value of 10.

12. A method according to claim 7, wherein the at least one pair of opposed attributes associated with the trait of core values is chosen from a group consisting of [courageous/fearful], [decisive/uncertain], [determined/indecisive], [disciplined/disordered], [focused/directionless], [improves self/stays the same], [nerves strong/jumpy], [organized/disorganized], [punctual/tardy], [reliable/undependable], [respects authority/rebellious], [accountable/irresponsible], [does what is right/does what is convenient], [honest/deceiving], [integrity/dishonest], [sincere/hypocritical] and [trustworthy/dishonest].

13. A method according to claim 7, wherein the at least one pair of opposed attributes associated with the trait of personality is chosen from a group consisting of [confident/insecure], [good/evil], [grateful/unappreciative], [mature/juvenile], [objective/biased], [outgoing/anti-social], [patient/impatient], [optimist/pessimist], [relaxed/stressed], [serious/flippant], [unpretentious/pretentious], and [well-balanced/uni-dimensional].

14. A method according to claim 7, wherein the at least one pair of opposed attributes associated with the trait of thinking process is chosen from a group consisting of [aware of opportunities/ignorant of opportunities], [clear direction/confused], [comprehends easily/hard time understanding], [embraces change/rejects change], [flexible/stubborn], [intelligent/obtuse], [knowledgeable/ignorant], [observant/oblivious], [openminded/guarded], [perfectionist/sloppy], [practical/unrealistic], [resourceful/uninspired], and [sees the whole picture/sees only parts of the picture].

15. A method according to claim 7, wherein the at least one pair of opposed attributes associated with the trait of relationship traits is chosen from a group consisting of [selfless/selfish], [clear communicator/confusing], [cooperative/unhelpful], [courteous/rude], [effective delegator/authoritarian], [forgiving/spiteful], [friendly/hostile], [generous/miserly], [interested/indifferent], [kind/mean], [leader/follower], [loyal/double-crossing], [tolerant/intolerant], [personable/distant], [polite/impolite], [sensitive/aloof], [sympathetic/unfeeling], [thoughtful/callous], and [trusting/jealous].

16. A method according to claim 7, wherein the at least one pair of opposed attributes associated with the trait of task skills is chosen from a group consisting of [ambitious/unmotivated], [energetic/easily tired], [enterprising/not creative], [enthusiastic/indifferent], [hard-working/lazy], [involved/complacent], [keen/reluctant], [persevering/relenting], [self-directed/needy], [strong/frail], [tough/weak], [achieves/doesn't achieve], [detail-oriented/sloppy], [efficient/wasteful], [professional/amateurish], [self-reliant/dependent], [self-directed/dependent], and [systematic/disorganized].

17. A system for generating an assessment profile of a candidate, comprising:
an assessment creator for obtaining at least one assessment of the candidate from a corresponding at least one reviewer;
an assessment weighter for deriving at least one weighted assessment corresponding to the at least one assessment of the candidate and an assessment profile of the corresponding at least one reviewer;
a profile generator for combining each of the at least one weighted assessments of the candidate to form the assessment profile of the candidate.

18. An assessment creator for obtaining an assessment of a candidate from a reviewer, wherein the assessment may be weighted in accordance with an assessment profile of the reviewer and combined with any other existing weighted assessments of the candidate from other reviewers to form an assessment profile of the candidate.

19. An assessment weighter for deriving a weighted assessment of a candidate from a reviewer comprising:
means for receiving an assessment of the candidate from the reviewer; and
means for retrieving an assessment profile of the reviewer;
whereby the assessment may be weighted by the assessment profile and combined with any other existing weighted assessments of the candidate from other reviewers to form an assessment profile of the candidate.

20. An assessment profile generator for generating an assessment profile of a candidate comprising:
means for receiving a first weighted assessment of the candidate from a first reviewer;
means for receiving a second weighted assessment of the candidate from a second reviewer; and
means for combining the first and second weighted assessments of the candidate into the assessment profile;
wherein the first and second weighted assessments are derived from respective assessments of the candidate by respective reviewers and an assessment profile of the respective reviewer.

21. A computer-readable medium in a processor for generating an assessment profile of a candidate, the medium having stored thereon, computer-readable and computer-executable instructions which, when executed by the processor, cause the processor to perform steps comprising:
a. obtaining at least one assessment of the candidate from a corresponding at least one reviewer;
b. weighting each of the at least one assessment of the candidate by an assessment profile of the corresponding at least one reviewer; and
c. combining each of the at least one weighted assessments of the candidate to form the assessment profile of the candidate.
